(19) United States
(12) Patent Application Publication
(10) Pub. No.: US 2009/0227451 A1
(43) Pub. Date: Sep. 10, 2009

(54) Encapsulated phase change materials in seed coatings

(76) Inventors: Simon A.H. Rose, Bradford (GB); Howard Roger Dungworth, Brighouse (GB); Martin Peter Butters, Bradford (GB)

Correspondence Address: JoAnn Villamizar;Ciba Corporation/Patent Department, 540 White Plains Road, P.O. Box 2005, Tarrytown, NY, 10591, US

(21) Appl. No.: 12/380,935

(22) Filed: Mar. 5, 2009

Related U.S. Application Data
(60) Provisional application No. 61/068,866, filed on Mar. 10, 2008.

(51) Int. Cl. A01C 1/06; A01C 1/00; A01N 25/26

(52) U.S. Cl. 504/100; 47/57.6; 47/58.1 SE

(57) ABSTRACT

The present invention is directed to improved seed coatings which facilitate fall or early spring planting while maintaining seed dormancy until soil temperatures are appropriate for successful germination. The improved seed coatings contain encapsulated phase change materials within a polymeric shell which preserve the dormancy of the seed during early planting by slowing the rate at which the seed temperature rises in the event of a temperature spike thus preventing premature germination. The encapsulated phase change material is a material characterized by a solid/liquid or liquid/solid phase change which occurs at a temperature which ranges from about −5 to about 20° C., preferably between about 0 to about 19° C., most preferably between about 5 to about 15° C. The solid/liquid or liquid/solid phase change is further characterized by an effective enthalpy of fusion/crystallization for the solid-liquid/liquid-solid phase change equal to or greater than 20 J/g when determined by Differential Scanning Calorimetry.

This application claims the benefit of Provisional Application No. 61/068,866, filed, Mar. 10, 2007 herein incorporated entirely by reference.

### FIELD OF THE INVENTION

The present invention relates to improved seed coatings which facilitate fall or early spring planting while maintaining seed dormancy until soil temperatures are appropriate for successful germination.

### BACKGROUND OF THE INVENTION

Timing of planting operations is frequently compromised by local weather conditions. Fields planted earliest in the spring will have a longer growing season but will be subjected to greater risk due to weather conditions and disease. Seeds planted later in the season are likely to provide lower yields due to a shorter growing period but are subjected to less risk. One of the most critical periods for crops is the period between the initial planting of the seed and germination.

It would be highly desirable to be able to plant in the fall or early spring seeds which would be protected from premature onset of germination that might result from spikes in temperature before the soil has reached a temperature which is supportive of the emerging seedling.

Premature germination is a known issue and there are a number of proposed solutions.

Polymeric seed coatings have been proposed which would allow early planting but protect the seed from premature germination. For example, U.S. Pat. No. 5,129,180 teaches seed coatings comprising a polymeric material. The polymeric material is characterized by a temperature dependent permeability to water. As water must reach the seed in order to stimulate germination and this can only occur at a suitable germination temperature, the seed remains dormant and protected until the right soil temperature conditions.

U.S. Pat. No. 6,230,438 teaches a water impervious coating to control germination until after exposure to freezing temperatures. Upon freezing the coating microfractures. Once the seed returns to temperatures above freezing, water passes through the fractures and germination begins.

There are numerous references which teach the use of phase change materials within a seed coating for the purposes of protecting the developing seedling from excessive heat conditions or from sporadic drops in temperature. Phase change materials are well known as materials which possess a relative high enthalpy of fusion as they undergo a solid-liquid/liquid-solid phase changes. For example, U.S. Pat. No. 6,057,266 utilizes microencapsulated phase change materials for enhanced seed germination and early growth. The phase change material provides a microclimate control coating that protects the seedlings or plants by minimizing damage from high temperature heat stress conditions. U.S. Pat. No. 6,057,266 attempts to maintain a more constant elevated microclimate control to speed up germination of the seed and protect the formed seedlings (germinated seeds) from drops in temperature.

U.S. Pat. No. 6,057,266 coats the seed with phase change materials which undergo a solid-liquid/liquid-solid phase change at temperatures of about 22° C. to 30° C. When a phase change material is used with a transition temperature in this range, the phase change material helps to speed up germination or protect the developing seedling from sudden drops in temperature. The present invention differs from US '266 by preventing germination of the seed before the soil temperatures become supportive to growth of the emerging seedling. The present invention proposes the use of phase change materials which undergo melting point or crystallization temperature which range from −5 to 20° C., preferably 0 to 19° C., and most preferably 5 to 10° C.

U.S. Pat. No. 7,220,761 and U.S. Published App. No 2006009416 teach the incorporation of phase change materials in combination with certain active ingredients. The phase change materials absorb thermal energy and thus protect the active from heat degradation.

There is still a need to protect seeds from premature germination when these seeds are planted in the fall and early spring in order to take maximum advantage of the full extent of the growing season. The present seed coating is designed to delay germination until the soil temperature range is most favourable for germination.

### SUMMARY OF THE INVENTION

The present invention provides for coating a seed wherein the seed coating comprises an encapsulated phase change material (PCM). The PCMs are normally water insoluble and undergo solid-liquid/liquid-solid phase changes at temperatures which range from about −5 to about 20° C., preferably from about 0 to about 19° C. and most preferably from about 5 to about 10° C. and display high effective enthalpy of the phase change.

The present invention is also directed to methods of maintaining the dormancy or preventing germination of the coated seed during spikes in temperature after planting which would lead to premature germination.

Thus the invention encompasses compositions and methods defined below:

A coated seed wherein the coating comprises
particles which comprise a core material within a polymeric shell and the core material is a phase change material characterized by a solid-liquid/liquid-solid phase change which occurs at temperatures which range from about −5 to about 20° C., and which solid-liquid/liquid-solid phase changes are further characterized by an effective enthalpy of fusion/crystallization for the solid-liquid/liquid-solid phase change of equal to or greater than 20 J/g when determined by Differential Scanning Calorimetry.

For example, the solid-liquid/liquid-solid phase changes may occur at temperatures which range from about 0 to about 19° C. and from about 5 to about 10° C.

The present invention embodies a method of maintaining the dormancy of a seed comprising the steps of

coating said seed with a composition comprising particles which comprise a core material within a polymeric shell and the core material is a phase change material, wherein the phase change material is a material characterized by a solid/liquid or liquid/solid phase change which occurs at temperatures which range from about −5 to about 20° C., preferably between about 0 to about 19° C., most preferably between about to about 10° C. and the solid/liquid or liquid/solid phase change is further characterized by an effective enthalpy of fusion/crystallization for the solid-liquid/liquid-solid phase change equal to or greater than 20 J/g when determined by Differential Scanning Calorimetry,
and
   planting the coated seed,
whereby premature seed germination is prevented by slowing the rate at which the seed temperature rises in the event of a temperature spike.

The above may also be expressed as

A method for preventing the germination of a seed comprising the steps of

coating said seed with a composition comprising particles which comprise a core material within a polymeric shell and the core material is a phase change material,
wherein the phase change material is a material characterized by a solid/liquid or liquid/solid phase change which occurs at a temperature between about −5 to about 20° C., preferably between about 0 to about 19° C., most preferably between about 5 to about 10° C. and the solid/liquid or liquid/solid phase change is further characterized by an effective enthalpy of fusion/crystallization of equal to or greater than 20 J/g,
and
   planting the coated seed,
whereby germination is prevented by slowing the rate at which the seed temperature rises in the event of a temperature spike.

A temperature spike is defined as an increase in soil temperature which may trigger germination of the seed. This increase in temperature or spike will depend upon the type of seed but will generally range from about 5 to 20° C.

The coated seed may be planted at any time during the year. For example, the PCM coated seed will normally be planted at times during the year when the soil is conducive to dormancy but before the ground is frozen, that is the soil temperature is below germination temperature but the ground may be turned.

For example, the coated seeds are planted about four weeks earlier than the usual planting time.

The usual planting time is time during the year that the soil temperature is conducive to germination. This will depend upon the type of seed.

The coated seeds of the invention show multiple advantages.

An advantage of the presently coated seed and method of planting said coated seed is said coated seed provides for greater flexibility and efficiency with respect to the timing of seed planting.

Another advantage of the present invention is the greater flexibility in the use of the labor force due to an expanded planting period without substantial risk of a need for replanting due to germination at undesirable low temperatures.

Another object of the present invention is to increase the yield of early planted food and fiber crops due to optimum germination control.

Another object of the invention is to reduce seed loss due to premature germination when the soil temperatures are too cold to support the growing seedling. This in turn reduces the planting rate and need for replanting, thus reducing overall production costs.

Still other advantages of the coated seeds is that they will allow early planting of the seeds so that the grower will be better able to utilize manpower resources and reduce scheduling conflicts with respect to manpower and equipment.

Another object of the invention is to effect germination timing by providing coated seeds which produce crops which mature in a more uniform manner (with respect to factors such as crop height) as compared to crops from uncoated seeds, thus allowing a larger percentage of the crop to be harvested at the same time.

Still another feature of the invention is that the coating with the encapsulated phase change material can be used in combination with other materials such as fertilizers, insecticides, fungicides, plant growth regulators, herbicides, Rhizobium inoculum and the like which enhance growth and/or or protect the seed or resulting organism against harmful diseases and/or elements.

Another object is to provide for coated seeds which are at or near the beginning of their growth cycle and have their growth temporarily suspended or controlled via a coating with a phase change material.

These and other objects, advantages and features of the invention will be apparent to those skilled in the art upon reading the details of the various coated seeds and seed coating formulation as set forth below.

### DETAILED DESCRIPTION OF THE INVENTION

The seeds coated with the encapsulated phase change materials may be any seeds. For example, seeds that might especially benefit from early planting provided the seeds do not prematurely germinate may include the following plants:

Brassica spp. Medicago sativa, Melilotus spp., Trifolium spp., Glycine max, Lens esculenta, Pisum sativum, Cicer arietinum, Phaseolus spp., Triticum spp., Hordeum spp., Secale cereale, X Triticosecale Wittmack), Carum carvi, Phalaris canatiensis, Coriandrum sativum L., Lolium spp., Zea mays, and Avena spps.

If the seeds are prevented from germinating (the dormancy of seed is preserved) until a critical soil temperature is reached, early seed planting will enable the planter to take full advantage of a relatively short growing season.

### Phase Change Materials (PCM)

Suitable phase change materials are organic, water insoluble materials that undergo solid-liquid/liquid-solid phase changes at useful temperatures (typically between −5 and 20° C.). Generally the enthalpy of phase change (latent heat of fusion and crystallization) is high. Suitable organic phase change materials per se (not encapsulated) exhibit a high enthalpy of phase change, typically equal to or >40 J/g, preferably equal to or >100 J/g and most preferably equal to or >150 J/g when determined by Differential Scanning Calorimetry (DSC).

Once the phase change material is encapsulated, the heat of fusion and crystallization of the combined materials (phase change material and encapsulant) will normally be reduced depending upon the encapsulant material and weight % of the phase change material making up the capsule. Thus for example, the particle which incorporates about 30 weight % of a phase change material of 150 J/g will give an effective latency or effective enthalpy of fusion or crystallization of about 50 J/g.

Therefore, the effective latency or effective enthalpy of fusion/crystallization for purposes of the invention means enthalpy of fusion/crystallization of the particles which particles include the phase change material core and surrounding polymer shell.

The effective latency or effective enthalpy of fusion/crystallization will be for example, equal to or >20 J/g, equal to or >30 J/g, equal to or >35 J/g and equal to or >40 J/g.

Suitable organic phase change materials include (but are not limited to) substantially water insoluble fatty alcohols, glycols, ethers, fatty acids, amides, fatty acid esters, linear hydrocarbons, branched hydrocarbons, cyclic hydrocarbons, halogenated hydrocarbons and mixtures of these materials. Alkanes (often referred to as paraffins), esters and alcohols are particularly preferred. Alkanes are preferably substantially n-alkanes that are most often commercially available as mixtures of substances of different chain lengths, with the major component, which can be determined by gas chromatography, between C₁₀ and C₅₀, usually between C₁₂ and C₃₂. Examples of the major component of an alkane organic phase change materials include n-octacosane, n-docosane, n-eicosane, n-octadecane, n-heptadecane, n-hexadecane, n-pentadecane and n-tetradecane. Suitable ester organic phase change materials comprise of one or more C₁-C₁₀ alkyl esters of C₁₀-C₂₄ fatty acids, particularly methyl esters where the major component is methyl behenate, methyl arachidate, methyl stearate, methyl palmitate, methyl myristate or methyl laurate. Suitable alcohol organic phase change materials include one or more alcohols where the major component is, for example, n-decanol, n-dodecanol, n-tetradecanol, n-hexadecanol, and n-octadecanol.

Representative phase change materials having a solid/liquid or liquid/solid transition from about −5 to about 20° C. are listed in Table 1 below.

TABLE 1

| | | Enthalpy of |
|---|---|---|
| Compound | | fusion/crystallization |
| Name/Tradename | Melting Point in ° C. | in J/g |
| Hexanoic acid | −4 | 204 |
| Tetradecane | 6 | 227 |
| Cetane | 18 | 228 |
| Capric alcohol | 6 | |
| Methyl laurate | 5 | |
| Butyl palmitate | 21 | |
| Butyl stearate | 21 | |
| Adipic acid, | 8 | |
| dimethyl ester | | |
| ¹RUBITHERM RT 2 | 6 | 214 |
| RUBITHERM RT -4 | −3 | 165 |
| RUBITHERM RT 5 | 7 | 156 |
| RUBITHERM RT 6 | 8 | 174 |

¹RUBITHERM products available from Rubitherm Technologies GmbH.

The phase change materials may also be mixtures of phase change materials with melting points or crystallization temperatures between about −5 C to about 20° C., preferably between about 0 to about 19° C. or about 0 to about 15° C. and most preferably between about 5 to about 15° C. or about 5 to about 10° C.

### Nucleating Agent

Typically the encapsulated organic phase change materials comprise the organic phase change material and optional additives such as a halogenated paraffin or a nucleating agent which is surrounded by a shell that is impermeable to the phase change material.

Although it is not essential, it is preferable to employ a nucleating agent with the phase change material to counter the effect known as supercooling or subcooling.

Supercooling is the effect whereby the organic phase change material crystallizes at a lower temperature than would normally be expected of the bulk, non-emulsified or non-encapsulated organic phase change material. The effect is most evident when the organic phase change material is isolated in independent microscopic domains, for example in an emulsion or microencapsulated form. For example, Differential Scanning Calorimetry (DSC) of microencapsulated organic phase change materials (without nucleating agent) may show one or more crystallization peaks occurring at lower temperatures than the one or more peaks for the organic phase change material in bulk (non-encapsulated) form.

Supercooling is usually undesirable as it can reduce the effective latent heat capacity of the organic phase change material. The use of a nucleating agent is particularly beneficial when the organic phase change material is in a particulate form below about 100 μm in mean diameter, particularly below about 50 μm and more particularly below about 10 to 20 μm, which is often the case when the organic phase change material is emulsified or microencapsulated. When an effective nucleating agent is blended into the organic phase change material, supercooling is markedly reduced or eliminated.

Preferably the nucleating agent is an organic material that is miscible with the organic phase change material at a temperature above the crystallization temperature of the organic phase change material and which exhibits a peak melting temperature at least 15° C. and preferably at least 20° C. higher than the peak melting temperature of the organic phase change material. The peak melting temperature is determined using a Differential Scanning Calorimeter (DSC) and when more than one melting peak is found, the peak melting temperature is determined from the largest peak. Suitable nucleating agents include those described in U.S. Pat. No. 5,456,852 (Mitsubishi Paper Mills) herein incorporated entirely by reference. The preferred nucleating agent is selected from a paraffin wax, fatty acid ester and fatty alcohol.

Paraffin waxes are particularly useful due to their effectiveness, cost and availability. Paraffin waxes with a peak melting temperature between 10° C. and 70° C., often between 20° C. and 35° C. and most often between 25° C. and 30° C. are cost-effective and readily available. These are particularly effective nucleating agents when the organic phase change material is essentially a normal paraffin. The peak melting temperature of the paraffin nucleating agent should be at least 15° C. and preferably at least 20° C. higher than the peak melting temperature of the organic phase change material. To reduce or eliminate supercooling one or more nucleating agent(s) is/are desirably mixed with the organic phase change material at a concentration by weight of 0.5% to 30%, preferably 2% to 20%, and more preferably 5% to 15% of the total weight of PCM and nucleating agent.

It is also possible to employ micro- or nanoparticles mixed into the phase change material as the nucleating agent e.g. nanoparticles of fumed silica, TiO₂ or other inorganic materials. In this case the micro/nanoparticle content (as a proportion of the total weight of nucleating agent particles including organic phase change material) tends to be 0.01% to 20%, preferably 0.05% to 10% and more preferably 0.1% to 5%.

Ideally the nucleating agent would have a melting temperature/crystallization temperature which ranges from about 15° C. to about 70° C.

In a preferred form of the invention the organic phase change material is encapsulated within a shell in the form of capsule particles. The encapsulation process will normally result in capsules with a substantially core-shell configuration. The core comprises of organic phase change material and the shell comprises encapsulating polymeric material. Usually the capsules are substantially spherical. Preferably the shell is durable such that the organic phase change material is protected from contamination and cannot easily escape from the capsules.

Since encapsulated organic phase change materials tend to be stable, solid entities, they can be provided in a range of particle sizes. It is possible to use capsules or particles in this invention with mean primary particle size of between 0.1 μm and 1 mm. For example, about 0.1 μm to about 10 μm or about 1 μm to about 5 μm mean particle size range are typical.

Generally, it is preferred to use smaller capsule particle sizes in this invention for a number of reasons. Smaller primary capsules tend to be more durable leading to inventive compositions which do not readily release organic phase change material. Due to their greater surface/volume ratio, smaller particle sizes are expected to give inventive compositions which more readily transfer heat to/from the particles of organic phase change material. It is generally possible for smaller capsules to be more uniformly distributed throughout a seed coating matrix.

The encapsulated phase change materials may be provided as a water or non-aqueous dispersion. The encapsulated phase change materials may also be provided as a powder for dry coating the seed. However, an aqueous dispersion may be most suitable as this form can be directly applied to a seed and will avoid dusting.

Dispersions of smaller capsules tend to exhibit the favourable property of better stability (reduced capsule creaming or settling) and the unfavourable property of increased viscosity compared to a dispersion of larger sized capsules at an equivalent concentration. It is also generally more difficult to prepare suitable capsules with very small particle sizes and/or the process required is more costly due to the extra processing that is required and/or the use of more specialized equipment. A balance must be found between these advantages and disadvantages and a volume mean diameter (VMD) of capsules (when in the form of an aqueous dispersion) of between 0.2 μm and 20 μm is usually chosen. Preferably the VMD of the capsules in an aqueous dispersion is between 0.7 μm and 10 μm and more preferably between 1 μm and 5 μm. VMD is determined by a Sympatec Helos particle size analyzer or another technique found to give results for microcapsules that are in very good agreement with the results from a Sympatec Helos analyzer.

The amount of shell material and amount of core material is chosen to give durable capsules containing the maximum amount of core material and hence maximum latent heat capacity. Frequently the core material or PCM forms at least 20% by weight of the capsule, preferably 50% to 98% and most preferably 85% to 95%.

The polymeric shell, for example, forms at least about 5%, at least about 8% or at least about 15% or about 20% of the total weight of the particles.

Microcapsules of core shell configuration may be formed from a number of different types of materials including aminoplast materials, particularly using melamine and urea e.g. melamine-formaldehyde, urea-formaldehyde and urea-melamine-formaldehyde, gelatin, epoxy materials, phenolic, polyurethane, polyester, acrylic, vinyl or allylic polymers etc.

For instance it is known to encapsulate hydrophobic liquids by dispersing the hydrophobic liquid into an aqueous medium containing a melamine formaldehyde pre-condensate and then reducing the pH resulting in an impervious aminoplast resin shell wall surrounding the hydrophobic liquid. Variations of this type of process are described in GB-A-2073132, AU-A-27028/88 and GB-A-1507739, in which the capsules are preferably used to provide encapsulated inks for use in pressure sensitive carbonless copy paper.

Microcapsules whose shells are composed of formaldehyde resins or cross-linked acrylic polymer are usually very robust as indicated by thermogravimetric analysis.

Acrylic types may be preferred as they are robust and do not liberate the toxic substance formaldehyde unlike capsules comprising formaldehyde resins.

U.S. Pat. No. 6,200,681 and herein incorporated entirely by reference describes microcapsules containing as a core a lipophilic latent heat storage material. The capsules are formed by polymerizing 30 to 100 wt. % C1-24 alkyl ester of (meth)acrylic acid, up to 80 weight % of a di- or multifunctional monomer and up to 40 weight % of other monomers. The microcapsules are said to be used in mineral molded articles.

Cross-linked acrylic polymers such as that disclosed in U.S. Publication No. 2007/224899 and also herein incorporated entirely by reference teach robust capsules. When the shell is robust, the organic phase change material is more securely contained within the polymer shell and less likely to escape from the capsules and compositions comprising the capsules. The inventors have discovered that these capsules are especially suitable for encapsulation of such ingredients as phase change materials.

U.S. Publication No. 2007/224899 discloses a polymeric shell used for encapsulating hydrophobic cores which comprises a copolymer formed from a monomer blend which comprises, A) 5 to 90% by weight of an ethylenically unsaturated water soluble monomer, B) 5 to 90% by weight of a multifunctional monomer, and C) 0 to 55% by weight other monomer and wherein the amount of the polymeric shell and the proportions of A, B and C are such that the particles exhibit a half height of at least 350° C.

Thus the polymeric shell encapsulating the core phase change material may be formed from for example, A) 5 to 90% by weight of an ethylenically unsaturated water soluble monomer, B) 5 to 90% by weight of a multifunctional monomer, and C) 0 to 55% by weight other monomer.

The water-soluble ethylenically unsaturated monomer component A desirably has a solubility in water of at least 5 g/100 cc at 25° C. For instance, it is at least partially soluble in or at least miscible with the hydrocarbon substance of the core. It may be a non-ionic monomer, such as acrylamide, methacrylamide, hydroxy ethyl acrylate or N-vinyl pyrrolidone. For example, the water-soluble monomer is ionic.

Desirably the ionic water-soluble monomer is an anionic monomer, and desirably contains a suitable acid moiety, for instance carboxylic acid or sulfonic acid. Preferably the anionic monomer is selected from the group consisting of acrylic acid, methacrylic acid, itaconic acid, maleic acid, vinyl sulfonic acid, allyl sulfonic acid and 2-acrylamido-2-methylpropane sulfonic acid, in the form of the free acid or water soluble salts thereof.

Methacrylic acid is a particularly preferred anionic monomer.

The ionic water-soluble monomer may also be a cationic monomer, having a suitable cationic functionality such as a quaternary ammonium group or a potentially cationic such as a tertiary amine group which can be ionized at low pH. Preferably the cationic monomer is selected from the group consisting of dialkyl amino alkyl acrylates, dialkyl amino alkyl methacrylates, dialkyl amino alkyl acrylamides, dialkyl amino alkyl methacrylamides and diallyl dialkyl ammonium halides, in the form of acid salts or quaternary ammonium salts. Particularly suitable cationic monomers include diallyl dimethyl ammonium chloride and the methyl chloride quaternary ammonium salts of dimethyl amino ethyl acrylate, dimethyl amino ethyl methacrylate, t-butylaminoethyl methacrylate, dimethyl amino propyl acrylamide, dimethyl amino propyl methacrylamide.

The multifunctional monomer, component B, should readily react with the water-soluble monomer to provide a cross linked structure. Desirably the multifunctional monomer contains at least two ethylenically unsaturated groups or alternatively may contain one ethylenically unsaturated group and one reactive group capable of reacting with other functional groups in any of the monomer components. Preferably, the multifunctional monomer is insoluble in water or at least has a low water-solubility, for instance below 5 g/100 cc at 25° C., but usually less than 2 or 1 g/100 cc. In addition the multifunctional monomer should be soluble or at least miscible with the hydrocarbon substance of the core material. Suitable multifunctional monomers include divinyl benzene, ethoxylated bisphenol A diacrylate, propoxylated neopentyl glycol diacrylate, tris(2-hydroxyethyl) isocyanurate triacrylate, trimethylolpropane triacrylate and an alkane diol diacrylate, for instance 1,3-butylene glycol diacrylate, 1,6-hexanediol diacrylate but preferably 1,4-butanediol diacrylate.

The monomer blend used to form the polymeric shell may also include up to 55% by weight other monomer (component C). In this monomer may be any suitable ethylenically unsaturated monomer that will readily copolymerizing with the water-soluble monomer (component A) and the multifunctional monomer (component B). Preferably, the other monomer is insoluble in water or at least has a low water-solubility, for instance below 5 g/100 cc at 25° C., but usually less than 2 or 1 g/100 cc. In addition the other monomer should preferably be soluble or at least miscible with the hydrocarbon substance of the core material. Particularly suitable monomers for use as component C include monomers selected from the group consisting of C₁₋₃₀ alkyl esters of ethylenically unsaturated carboxylic acid, styrene, vinyl acetate, acrylonitrile, vinyl chloride and vinylidene chloride. Particularly suitable monomers are C₁₋₈ alkyl esters of acrylic or methacrylic acid, preferably methyl methacrylate.

Capsules may be formed by any convenient encapsulation process suitable for preparing capsules of the correct configuration and size. Various methods for making capsules have been proposed in the literature. Processes involving the entrapment of active ingredients in a matrix are described in general for instance in EP-A-356,240, EP-A-356,239, U.S. Pat. No. 5,744,152 and WO 97/24178. Typical techniques for forming a polymer shell around a core are described in, for instance, GB 1,275,712, 1,475,229 and 1,507,739, DE 3,545,803 and U.S. Pat. No. 3,591,090.

Emulsion polymerization is one process for preparing particles encapsulating the phase change materials. For example, a monomer blend is combined with the hydrophobic substance (PCM) and emulsified into an aqueous medium thus forming a dispersed hydrophobic phase (preferably organic) in a continuous aqueous phase.

The process may employ an emulsifying system, for instance emulsifiers, other surfactants and/or polymerization stabilizers. Thus an emulsifier, which may have a high HLB is dissolved into water prior to emulsification of the monomer solution. Alternatively the monomer solution may be emulsified into water with a polymerization stabilizer dissolved therein. The polymerization stabilizer can be a hydrophilic polymer, for example a polymer containing pendant hydroxyl groups, for instance a polyvinyl alcohol and hydroxyethylcellulose. The polyvinyl alcohol stabilizer may be derived from polyvinyl acetate, and preferably between 85 and 95%, especially 90% of the vinyl acetate groups are hydrolyzed to vinyl alcohol units.

The polymerization step may be effected by subjecting the aqueous monomer solution to any conventional polymerization conditions. Typically, the monomer is subjected to free radical polymerization. Generally polymerization is effected by the use of suitable initiator compounds. Desirably this may be achieved by the use of redox initiators and/or thermal initiators. Typically redox initiators include a reducing agent such as sodium sulphite, sulphur dioxide and an oxidizing compound such as ammonium persulphate or a suitable peroxy compound, such as tertiary butyl hydroperoxide etc. Redox initiation may employ up to 1000 ppm, typically in the range 1 to 100 ppm, normally in the range 4 to 50 ppm.

Preferably the polymerization step is initiated by employing a thermal initiator alone or in combination with other initiator systems, for instance redox initiators. Thermal initiators would include any suitable initiator compound that releases radicals at an elevated temperature, for instance azo compounds, such as azobisisobutyronitrile (AZDN), 4,4′-azobis-(4-cyanovalereic acid) (ACVA) or t-butyl perpivilate. Typically thermal initiators are used in an amount of up 50,000 ppm, based on weight of monomer. In most cases, however, thermal initiators are used in the range 5,000 to 15,000 ppm, preferably around 10,000 ppm. Preferably a suitable thermal initiator is combined with the monomer prior to emulsification and polymerization is effected by heating the emulsion to a suitable temperature, for instance at least 50 or 60° C. or higher for sufficient time to effect polymerization. More preferably, the process is effected by maintaining the emulsion at for example, a temperature of between 50 and 80° C. for a period of between 90 and 150 minutes. In such cases it may be desirable to subsequently subject the emulsion to a temperature of at least 80° C. for a period of at least 30 minutes, for instance up to 90 minutes.

Robustness of the capsules for purposes of the invention may be determined by thermogravimetric analysis (TGA). “Half Height” is the temperature at which 50% of the total mass of dry (water-free) capsules is lost as a fixed mass of dry capsules is heated at a constant rate. In this analysis method, mass may be lost due to organic phase change material escaping as vapour permeating through the shell and/or due to rupturing of the shell. Particularly suitable microcapsules of organic phase change material (in the 1 μm to 5 μm mean particle size range) have a Half Height value greater than 250° C., preferably greater than 300° C. and more preferably greater than 350° C., when TGA is carried out using a Perkin-Elmer Pyris 1 at a rate of 20° C. per minute using typically 5 to 50 mg of dry sample.

Either the dried microcapsules containing the phase change materials or dispersions (aqueous or non-aqueous) containing the microcapsules may then be further mixed with a film forming polymer and other formulation aids including colorants, antifreeze agents, carriers, suspending aids and seed coating binder, other active ingredients such as fertilizers, insecticides, fungicides, plant growth regulators, herbicides, Rhizobium inoculum and the like which enhance growth and/or or protect the organism against harmful diseases and/or elements to produce a seed coating.

The particles which comprise a phase change material core, said particles will typically make up about 1 to about 75% of the total weight of the seed coating (after drying).

If the microcapsules contain for example about 85-95 wt. % of phase change material, then the dried seed coating will contain between about 0.5 to about 70 wt. % active phase change material. Seed coatings containing about 1-50 wt. % active phase change material or preferably about 5 to about 20 wt. % phase change material where the melting point of the phase change material −5 and 20° C., preferably between 0 and 19° C. maintains the seed at a reduced temperature thus delaying germination of the seed.

The film forming polymers are for example water-soluble and/or water-dispersible film-forming polymers. The aqueous compositions generally contain from about 0.5% to about 10% film forming polymers by weight of the seed coating composition.

Suitable film forming polymers for example are alkyleneoxide random and block copolymers such as ethylene oxide-propylene oxide block copolymers (EO/PO block copolymers) including both EO-PO-EO and PO-EO-PO block copolymers; ethylene oxide-butylene oxide random and block copolymers, C₂₋₆ alkyl adducts of ethylene oxide-propylene oxide random and block copolymers, C₂₋₆ alkyl adducts of ethylene oxide-butylene oxide random and block copolymers, polyoxyethylene-polyoxypropylene monoalkylethers such as methyl ether, ethyl ether, propyl ether, butyl ether or mixtures thereof, vinylacetate/vinylpyrrolidone copolymers, alkylated vinylpyrrolidone copolymers, polyvinylpyrrolidone, and polyalkyleneglycol including the polypropylene glycols and polyethylene glycols.

Specific examples of suitable polymers include Pluronic P103 (BASF) (EO-PO-EO block copolymer), Pluronic P65 (BASF) (EO-PO-EO block copolymer), Pluronic P108 (BASF) (EO-PO-EO block copolymer), Vinamul 18160 (National Starch) (polyvinylacetate), Agrimer 30 (ISP) (polyvinylpyrrolidone), Agrimer VA7w (ISP) (vinyl acetate/vinylpyrrolidone copolymer), Agrimer AL 10 (ISP) (alkylated vinylpyrrolidone copolymer), PEG 400 (Uniqema) (polyethylene glycol), Pluronic R 25R2 (BASF) (PO-EO-PO block copolymer), Pluronic R 31R1 (BASF) (PO-EO-PO block copolymer) and Witconol NS 500LQ (Witco) (butanol PO-EO copolymer).

The inorganic solid carrier is for example a natural or synthetic solid material that is insoluble in water. This carrier is generally inert and acceptable in agriculture, especially on the treated seed or other propagation material. It can be chosen, for example, from clay, diatomaceous earth, natural or synthetic silicates, titanium dioxide, magnesium silicate, aluminum silicate, talc, pyrophyllite clay, silica, attapulgite clay, dieselguhr, chalk, lime, calcium carbonate, bentonite clay, Fuller's earth, and the like such as described in the CFR 180.1001 (c) & (d).

Specific examples of suitable antifreezes include ethylene glycol, 1,2-propylene glycol, 1,3-propylene glycol, 1,2-butanediol, 1,3-butanediol, 1,4-butanediol, 1,4-pentanediol, 3-methyl-1,5-pentanediol, 2,3-dimethyl-2,3-butanediol, trimethylol propane, mannitol, sorbitol, glycerol, pentaerythritol, 1,4-cyclohexanedimethanol, xylenol, bisphenols such as bisphenol A or the like. In addition, ether alcohols such as diethylene glycol, triethylene glycol, tetraethylene glycol, polyoxyethylene or polyoxypropylene glycols of molecular weight up to about 4000, diethylene glycol monomethylether, diethylene glycol monoethylether, triethylene glycol monomethylether, butoxyethanol, butylene glycol monobutylether, dipentaerythritol, tripentaerythritol, tetrapentaerythritol, diglycerol, triglycerol, tetraglycerol, pentaglycerol, hexaglycerol, heptaglycerol, octaglycerol and the like.

The coloring agent, such as a dye or pigment (and the like such as described in the CFR 180.1001) is included in the seed coating so that an observer can immediately determine that the seeds are treated. The dye is also useful to indicate to the user the degree of uniformity of the coating applied.

The seed coating may contain binders which help the coating suspension concentrate containing the microcapsules of the invention stick to the seed. These binders may be an adhesive polymer and may be natural or synthetic. Typical binder may be polyvinyl acetates, polyvinyl alcohols, polyvinyl alcohol copolymers, celluloses, including ethylcelluloses and methylcelluloses, hydroxymethylcelluloses, hydroxyproylcellulose, polyvinyl pyrolidones, dextrins, matodextrins, polysaccharides, fats, oils, proteins, gum arabics shellacs, vinylidene chloride and vinylidene chloride copolymers.

The seed coating suspension concentrate may also contain fillers. It is known that the use of fillers in the seed coating protects the seed during stress condition. Fillers such as woodflours, clays, activated carbon, sugars, diatomaceous earth, cereal flours, fine-grain inorganic solids, calcium carbonate and the like may be used.

The seed coatings will contain for example about 1% to about 75% by weight of PCM microcapsules. As the microcapsules contain about 20% active PCM by weight of the capsule, preferably 50% to 98% active PCM by weight of the capsule and most preferably 85% to 95% active PCM by weight of the capsule, the dried seed coating will contain between about 0.2 to about 15%, between about 0.5 to about 75% and between about 0.5 to about 70% by weight active PCM.

### Example 1

The PCM microcapsules are obtained as follows.

An oil phase is prepared by mixing together 45:15:40 by weight methacrylic acid, methyl methacrylate and butanediol diacrylate monomers (271.7 g) with homogenous molten core material composed of RUBITHERM RT 6 (1761.0 g, the PCM) and a paraffin with a peak melting temperature of about 30° C. (142.8 g, nucleating agent). The oil phase is maintained just above the solidification temperature of the core material i.e. −35° C. to prevent any solidification of the core material. Lauroyl peroxide (thermal initiator) (2.7 g) is added to the oil phase. The oil phase is homogenised into water (2746.2 g) containing polyvinyl alcohol (Gohsenol GH20) (67.4 g) using a Silverson mixer (with fine shroud) for 5 minutes to form a stable emulsion. The emulsion is then transferred into a reactor with a stirrer, thermometer and gas bubbler connected to a nitrogen supply. The stirred emulsion is deoxygenated with nitrogen for 20 minutes. Throughout all of these initial steps (and until cooling at the end of the preparation process) the core material is maintained in a molten state.

The contents of the reactor are then heated to 60° C. and maintained at this temperature for 2 hours after which the contents are heated to 80° C. and then maintained for a further 1 hour before being cooled and filtered. The resulting dispersion contains core-shell microcapsules with a core of 90% w/w RUBITHERM RT 6 and 10% w/w paraffin nucleating agent and a shell of highly cross-linked acrylic polymer, and whereby the microcapsules comprise 87.5% w/w core and 12.5% w/w shell. The dispersion has a solids content of 45% w/w when 1 gram is dried for 1 hour at 110° C. and volume mean diameter of 2.0 microns determined using a Sympatec Helos laser diffraction system with an R1 lens (0.18-35 μm) and Quixcel dispersion system. The dispersion has a latent heat capacity of 45 J/g (melting transition) and 45 J/g (crystallization transition) and a peak melting temperature of 8.0° C. and peak crystallization temperature of 5° C. as determined by differential scanning calorimetry (DSC) using a Perkin-Elmer Pyris 1 from −10 to 50° C. using a heating and cooling rate of 5° C./minute with sample weight of around 20 mg.

### Example 2

### Seed Coating Containing Encapsulated Phase Change Material

A pesticide wettable powder (200 g) is mixed with water (620 g) and 80 g of the PCM microcapsule dispersion (45 wt. %) formed in example 1. The weight of dry capsules is 36 g. A solid grade film forming polymer is added (90 g of AGRIMER VA6 available from ISP) along with a dye (10 g). The resulting seed coating composition contains approximately 10 wt. % PCM on drying. The seed coating composition is coated onto seeds which display delayed emergence when planted in cold soil.

We claim:

1. A coated seed wherein the coating comprises
particles which comprise a core material within a polymeric shell and the core comprises a phase change material characterized by a solid-liquid/liquid-solid phase change which occurs at temperatures which range from about −5 to about 20° C., and which solid-liquid/liquid-solid phase changes are further characterized by an effective enthalpy of fusion/crystallization for the solid-liquid/liquid-solid phase change of equal to or greater than 20 J/g when determined by Differential Scanning Calorimetry.

2. The coated seed according to claim 1, wherein the effective enthalpy of fusion/crystallization is equal to or greater than 30 J/g when determined by Differential Scanning Calorimetry.

3. The coated seed according to claim 1, wherein the solid-liquid/liquid-solid phase change which occurs at a temperature which ranges from about 0 to about 19° C.

4. The coated seed according to claim 1, wherein the solid-liquid/liquid-solid phase change which occurs at a temperature which ranges from about 5 to about 15° C.

5. The coated seed according to claim 1, wherein the core includes a nucleating agent.

6. The coated seed according to claim 1, wherein the coating further comprises an active ingredient which enhances growth and/or or protects the seed or resulting organism against harmful diseases and/or elements.

7. The coated seed according to claim 6, wherein the active ingredient is selected from the group consisting of fertilizers, insecticides, fungicides, plant growth regulators, herbicides and Rhizobium inoculum.

8. The coated seed according to claim 1, wherein the polymeric shell is formed from A) 5 to 90% by weight of an ethylenically unsaturated water soluble monomer, B) 5 to 90% by weight of a multifunctional monomer, and C) 0 to 55% by weight other monomer.

9. The coated seed according to claim 1, wherein the particle has a mean primary particle size of between 0.1 μm and 1 mm.

10. The coated seed according to claim 1, wherein the phase change material makes up at least 20% by weight of the particle.

11. The coated seed according to claim 1, wherein the seed coating upon drying will contain between about 0.5 to about 70 wt. % phase change material.

12. A method of maintaining the dormancy of a seed comprising the steps of coating said seed with a composition comprising
particles which comprise a core material within a polymeric shell and the core comprises a phase change material, wherein the phase change material is a material characterized by a solid/liquid or liquid/solid phase change which occurs at a temperature which ranges from about −5 to about 20° C. and the solid/liquid or liquid/solid phase change is further characterized by an effective enthalpy of fusion/crystallization for the solid-liquid/liquid-solid phase change equal to or greater than 20 J/g when determined by Differential Scanning Calorimetry,
and
planting the coated seed,
whereby premature seed germination is prevented by slowing the rate at which the seed temperature rises in the event of a temperature spike.

13. A method for preventing the germination of a seed comprising the steps of
coating said seed with a composition comprising particles which comprise a core material within a polymeric shell and the core comprises a phase change material,
wherein the phase change material is a material characterized by a solid/liquid or liquid/solid phase change which occurs at a temperature which ranges from about −5 to about 20° C. and the solid/liquid or liquid/solid phase change is further characterized by an effective enthalpy of fusion/crystallization for the solid-liquid/liquid-solid phase change equal to or greater than 20 J/g when determined by Differential Scanning Calorimetry,
and
planting the coated seed,
whereby germination is prevented by slowing the rate at which the seed temperature rises in the event of a temperature spike.

14. The method according to claim 12, wherein the coated seed is planted in the fall or early spring or about four weeks earlier than the normal planting time.

15. The method according to claims 12, wherein the particle has a mean primary particle size of between 0.1 μm and 1 mm.

16. The method according to claim 12, wherein the phase change material makes up at least 20% by weight of the particle.

17. The method according to claim 12, wherein the seed coating upon drying will contain between about 0.5 to about 70 wt. % phase change material.
